(19) United States
(12) Patent Application Publication
(10) Pub. No.: US 2019/0343271 A1
(43) Pub. Date: Nov. 14, 2019

(54) ELECTROMOTIVE FURNITURE DRIVE AND ITEM OF FURNITURE

(71) Applicant: DewertOkin GmbH, 32278 Kirchlengern (DE)

(72) Inventor: Armin Hille, Bielefeld (DE)

(73) Assignee: DewertOkin GmbH, 32278 Kirchlengern (DE)

(21) Appl. No.: 16/335,193

(22) PCT Filed: Sep. 21, 2017
(86) PCT No.: PCT/EP2017/073950

§ 371 Date: Mar. 20, 2019

(30) Foreign Application Priority Data
Sep. 21, 2016 (DE) 20 2016 105 266.1

(51) Int. Cl. A47B 9/00; A47C 7/50; G05B 19/042

(52) U.S. Cl. CPC A47B 9/00; A47C 7/506; G05B 2219/49159; A47B 2200/0061; G05B 2219/25257; G05B 19/0428

(57) ABSTRACT

The invention relates to an electric motor-driven furniture drive mechanism (4) for adjusting moveable components of an item of furniture (1), in particular functional furniture, comprising at least one electric motor-driven adjustment drive mechanism (4a, 4b) having a control device (5) and at least one operating device (6), a monitoring device (7) having at least one detection device (10) for monitoring at least one monitoring region (9) and forming an anti-trap protection system for the associated item of furniture (1). The electric motor-driven furniture drive mechanism (4) is characterised in that the at least one detection device (10) has at least one sensor unit (11) which is in the form of or comprises a piezo cable. The invention also relates to an item of furniture having an electric motor-driven furniture drive mechanism (4).

The invention relates to an electromotive furniture drive according to the preamble of claim 1 as well as an item of furniture with such a furniture drive mechanism.

Such an electromotive furniture drive is used to adjust movable furniture and/or furniture components. In this case, the adjustment movement and drive force generated by the electromotive furniture drive are transmitted to the respective movable furniture component, wherein the electromotive furniture drive is supported on a fixed furniture component and the movable furniture component is adjusted relative to the fixed furniture component. The electromotive furniture drive can also be mounted between two movable furniture components, wherein it can adjust these relative to each other.

An adjustable furniture item, in particular functional furniture, is provided with at least one electromotive furniture drive mechanism. Such an electromotive furniture drive is mounted in the furniture, which has fixed and movable furniture components. Fixed furniture components are, for example, frame components, panels and the like. Movable furniture components are, for example, fixed or spring-compliant supporting surfaces of upholstery or a mattress of seating and/or reclining furniture. They can also be, for example, height-adjustable legs of a table, desk or the like. For example, electric adjustment drive motors, also called adjustment drive mechanisms, are built into an armchair for movable armchair components. Movable furniture components are attached to the furniture or furniture components with so-called movable fittings.

Electromotive furniture drive mechanisms according to the prior art are known in a large number of different designs for different applications and purposes, e.g. as single drives, double drives and multiple drives.

The electric adjustment drive motors of the electromotive furniture drive mechanisms are usually operated manually by means of an actuating device, wherein the respective motor is adjusted at the push of a button. These actuating devices are connected, for example, via a connecting cable to a control unit of the electromotive furniture drive mechanism. However, wireless actuating devices are also possible, e.g. by radio, infrared, ultrasound. Armchairs, for example, have built-in control units in some designs.

In the case of furniture, e.g. height-adjustable furniture such as tables, stand-up chairs, there may be danger points due to clamping and squeezing both for an operator and for persons, animals and objects located next to the furniture. In this respect, different measures have been proposed to protect against clamping or squeezing, With regard to persons and animals, this is usually referred to as anti-trap protection, and with regard to objects, e.g. roll containers standing under a table or computer technology systems, it is often referred to as system protection.

For example, there are capacitive sensor systems that use the metal fittings of a movable furniture component as an antenna and can thus form a proximity and/or touch sensor. Ultrasonic sensors have also been proposed.

Document DE 297 18 426 U1 is mentioned here as an example. It describes an adjustment device for movable furniture parts of a piece of furniture with an electromotive furniture drive and a metal fitting and/or frame coupled thereto and with a sensor unit for detecting approach or contact of the fitting or frame and with a control unit. The fitting itself can be designed as an antenna.

A disadvantage is seen in the fact that due to different environmental conditions, the fitting designed as an antenna does not always provide clear results in terms of anti-trap protection. If the electrical or electromagnetic field is designed in such a way that significant and measurably reproducible success can actually be achieved in the sense of real anti-trap protection, the system moves from the originally intended character of a range sensor to a touch sensor. Also a response with objects in the sense of a system protection is not securely provided.

In the case of ultrasonic sensing, it is essentially the other way round. Ultrasonic sensors can be used to monitor larger areas very well, although there are currently still some limitations with smaller distances (as is often the case with furniture). If an object or a small animal is already between two fitting parts before start-up, in particular with a scissor fitting (footrest rest chair is mentioned as an example), switching on of the associated drive should not take place at all.

The operational reliability of larger furniture items is the biggest problem because faults can occur due to faulty field derivation and faulty field application. Thanks to the evaluation electronics, these can be reduced by the automatic offset correction, but individual sections on the furniture cannot be monitored in detail. Furthermore, the evaluation is not spatially limited—i.e. it goes beyond the boundaries of the furniture, which leads to false identifications—and does not react to dead objects.

It is therefore the object of the present invention to create an improved electromotive furniture drive with an improved detection device as anti-trap protection or system protection.

The object is solved by an electromotive furniture drive or an item of furniture with the features of the respective independent claim.

An electromotive furniture drive according to the invention for adjusting movable components of an item of furniture, in particular functional furniture, has at least one electromotive adjustment drive mechanism with a control device and at least one operating device, a monitoring device having at least one detection device for monitoring at least one monitoring region and forming an anti-trap protection system for the associated item of furniture. The at least one detection device has at least one sensor unit which is in the form of or comprises a piezo cable.

A piezo cable usually has at least two (metallic) conductors that are insulated from each other by an insulating material. In a piezo cable, at least sections of the insulating material are formed by a piezo material or comprise a piezo material. A change in shape of the piezo cable, such as bending or squeezing, leads to a change in pressure on the piezo material, which builds up a voltage which is applied to the two conductors and can therefore be picked up and detected at a connection of the piezo cable.

The piezo cable can easily be routed along edges or surfaces of the furniture, for example, where there is a risk of clamping. The piezo cable can be easily and flexibly adapted to an area of the furniture to be monitored, even if it has a geometrically complex shape.

In principle, the piezo cable is connected to the furniture or furniture component. The connection itself is preferably indirect, wherein the shape and/or position of the piezo cable relative to the furniture component changes in the event of clamping. In a first clamping case the distance or shape of the piezo cable relative to the furniture component changes locally in the clamping area. In particular, bends occur in this case on the piezo cable, which then generate the electrical voltage for evaluating the clamping case.

In a second clamping case, a change in shape and/or position occurs for both the piezo cable and the furniture component that is operatively connected to it. The cause is a very clear clamping case or a rather flexible furniture component.

In another clamping case, the piezo cable is directly connected to the furniture component, wherein changes in shape and/or position of the furniture component are transmitted directly to the piezo cable.

An item of furniture in accordance with the invention has such a furniture drive mechanism. The at least one monitoring region with the detection device can be a three-dimensional area located below the furniture between fittings and joints. It is therefore also possible to monitor internal areas of the furniture in such a way that objects and/or animals that have entered an unused piece of furniture can be detected and protected from damage. An anti-trap protection also protects the furniture from damage if objects are clamped or possibly clamped.

In one embodiment, the sensor unit is provided with at least one support as underpadding. This allows the sensor unit to be bent when actuated to generate a unique signal. The support can also be used for easy assembly.

For this purpose, the sensor unit can be provided with at least one sheath. This creates a simple but effective protection.

In another embodiment, the sensor unit can be automatically reset after deformation by an actuating force. This is how the detection device is quickly ready for use again. The sheath can also be used for automatic resetting due to an elastic material.

It is advantageous that the sensor unit has two electrically conductive cables as connecting lines. In this case, one cable can be used as shielding. This reduces the susceptibility to interference from external electromagnetic fields.

In one embodiment, the sensor unit is designed as a piezo cable with a round cross-section. This is particularly cost-effective to manufacture.

Alternatively, the sensor unit can be designed as a flat cable, which saves space.

In another embodiment, the flat cable can be a flexible printed circuit board. This is advantageous, for example, for automatic production.

In another advantageous embodiment of the electromotive furniture drive mechanism, the monitoring device is designed to evaluate signals from at least one detection device with regard to an amplitude and/or a signal characteristic. In this case, the signal can be assigned to different events on the basis of the amplitude and/or the signal characteristics. By looking at measured quantities of the signal and/or its progression, actual clamping events can be distinguished from interfering events or other events, thereby increasing operational safety and reliability.

If a clamping event is detected, the monitoring device and the control device may be arranged to slow down, stop and/or reverse, at least for a short time, the direction of movement of at least one electromotive adjustment drive mechanism.

In a preferred further development, it can be provided that certain vibrations such as knocking on a table top or tapping on the table top in a certain predetermined rhythm (pattern) are detected. One or more knocking or touch patterns can be distinguished from each other and used, for example, to control the adjustment drive mechanisms.

It may also be provided that the control device or the monitoring unit of the furniture drive mechanism has at least one separate signal or switching output which is activated after recognition of a predetermined or teachable knocking or tapping pattern and triggers or switches connected devices such as a luminaire.

The invention can be used as anti-trap protection or system protection for any furniture with squeezing and shearing points in the danger zone.

The invention is explained in more detail on the basis of the attached drawings, wherein:

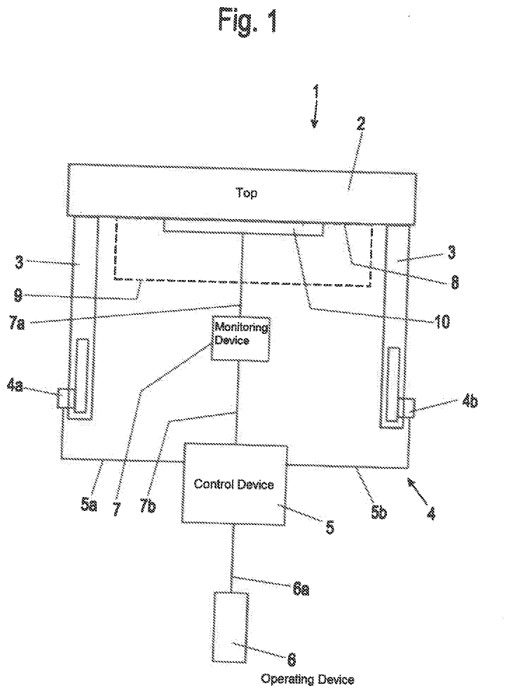

FIG. 1 shows a schematic representation of an exemplary piece of furniture with an embodiment example of an electromotive furniture drive according to the invention with a detection device according to the invention;

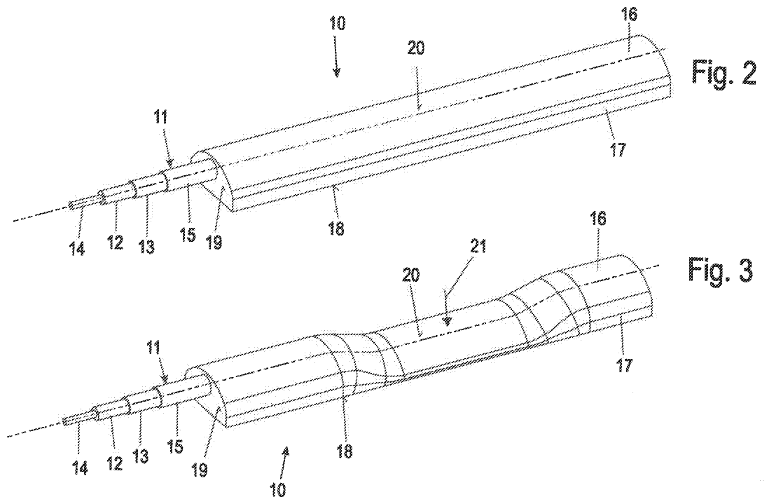

FIG. 2 shows a schematic representation of the detection device according to the invention and according to FIG. 1 in an unactuated state;

FIG. 3 shows the detection device according to FIG. 2 in an actuated state;

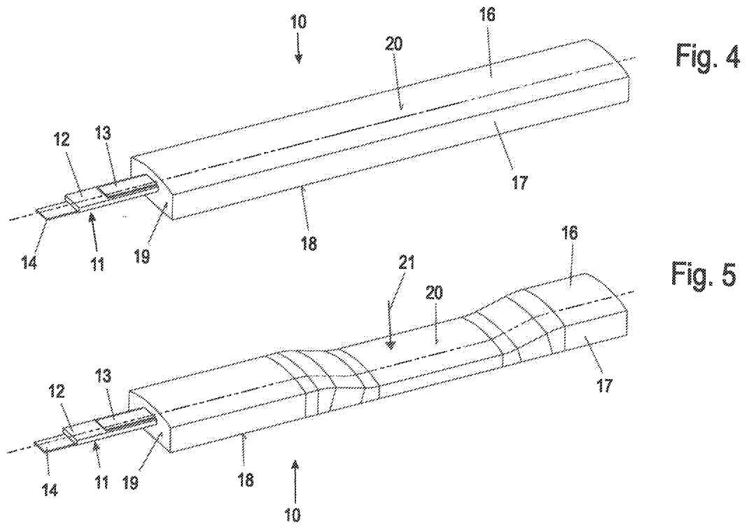

FIG. 4 shows a schematic representation of a variant of the detection device according to the invention and according to FIG. 1 in an unactuated state; and

FIG. 5 shows the detection device according to FIG. 4 in an actuated state;

FIG. 1 shows a schematic representation of an exemplary item of furniture 1 with an embodiment example of an electromotive furniture drive 4 according to the invention having a detection device 10 according to the invention.

Furniture 1 here is a so-called item of functional furniture, in this example a height-adjustable table with a top 2 standing on height-adjustable support legs 3, of which only two are shown here, Two adjustment drive mechanisms 4a, 4b are shown here to represent an adjustment function of the support legs 3. For example, each support leg 3 can have one adjustment drive mechanism 4a, 4b.

The electromotive furniture drive 4 comprises at least one adjustment drive mechanism 4a, 4b, a control device 5 and an operating unit 6. The adjustment drive mechanisms 4a, 4b are provided for adjusting the height-adjustable support legs 3 and thus the top 2 and are electrically connected to the control device 5 via drive lines 5a, 5b. The operating unit 6 is used to operate the adjustment drive mechanisms 4a, 4b and is connected to the control device 5 either with an electrically conductive cable as a wire-bound transmission path 6a or to the control device 5 via a wireless transmission path 6a.

The electromotive furniture drive 4 also has a monitoring unit 7 with at least one detection device 10 for implementing anti-trap protection. In the example shown here, an underside of top 2 may present a risk of clamping at a clamping edge 8 for persons, animals and objects. A monitoring region 9, in which such a clamping risk may exist, is only schematically indicated and dashed.

The detection device 10 is connected to the monitoring unit 7 via a connecting line 7a, wherein the monitoring unit 7 is connected to the control device 5 via a further connection cable 7b. The monitoring unit 7 can also be part of the control device 5.

Furthermore, it is conceivable that the monitoring unit 7 is part of the control unit 5, especially if it is mounted on the furniture and/or if it is designed to switch currents of the adjustment drive mechanisms 4a, 4b directly. The control device 5 can also be part of at least one support leg 1, an adjustment drive mechanism 4a, 4b and/or a furniture component, e.g. top 2.

An example of a detection device 10 is shown here. Depending on the geometry and dimensions of the monitored furniture, it may be useful to use several detection devices 10, for example if monitoring regions are spaced apart from each other or very large. For reasons of operational reliability, it is advantageous not to form a single detection device too large, in particular not too long, in order to omit an antenna effect against electrical interference signals. A length of less than 2 meters (m) and in particular less than 1 m is preferred in this respect.

In order to be able to use more than one detection device, the monitoring unit 7 may have more than one input for connection of a respective detection device 10, which is preferably evaluated electrically independently of each other. An evaluation can be carried out in parallel, or a time-division multiplex procedure can be carried out rotating one after the other at short intervals. The latter makes it possible to realize a monitoring unit 7 with several inputs with little switching effort.

For the evaluation of the input signals, the monitoring unit 7 advantageously comprises at least one filter, at least one amplifier, optionally with adjustable amplification factor and/or an input protection circuit for voltage division and/or limitation.

It is also possible to use several independent monitoring units 7, whose output signals are then evaluated by the control unit 5.

FIG. 2 shows a schematic representation of the detection device 10 according to the invention and according to FIG. 1 in an unactuated state, and FIG. 3 shows an actuated state in this respect.

The detection device 10 is equipped with at least one sensor unit 11.

The sensor unit 11 has a so-called piezo cable and comprises a sensor element 12, two electrically conductive lines 13, 14 and an insulation 15.

The sensor unit 11 is inserted in a sheath 16 and mounted on a support 17.

The support 17 has a fixing side 18, with which the detection device 10 can be fixed to the clamping edge 8 of furniture 1, e.g. screwed, glued, stapled, etc.

The free surface of the sheath 16, which here is opposite the fixing side 18, has an actuating side 20 which is deformed against the support 17 by the action of an actuating force 21.

When the actuating force 21 is applied, the piezo cable of the sensor unit 11 is bent through the sheath 16 and generates an electrical signal (an electrical voltage, a voltage pulse or several voltage pulses), which is detected in an electrically conductive manner by the lines 13, 14 and transmitted via the connecting line 7a to the monitoring unit 7. In this example, the monitoring unit 7 amplifies the signal and evaluates it in such a way that in the event of a detected clamping, the control unit 5 receives a signal to switch off the adjustment drive mechanisms 4a, 4b if they were previously switched on. If the adjustment drive mechanisms 4a, 4b were not previously switched on, the signal influences control unit 5 in such a way that the adjustment drive mechanisms 4a, 4b cannot be switched on. It is also possible that in these cases the adjustment drive mechanisms 4a, 4b are automatically driven in the opposite direction for a short time.

A deformed cable, which can be laid anywhere in/on the furniture 1, in the form of the detection device 10 or/and as sensor unit 11, does not supply an electrical signal on the lines 13, 14 in the unactuated state, but only in the actuated state.

A deformed cable, which can be laid anywhere in/on the furniture, in the form of a detection device 10 or/and sensor unit 11 designed in the form of a piezo cable, does not supply an electrical signal on the lines 13, 14 in the respective steady state, but only in the state during operation. This electrical signal is designed as a voltage signal.

The detection device 10 with the piezo cable as sensor unit Ills bent or squeezed in the event of actuation, i.e. in the event of clamping, which compresses the piezo material contained.

The electrical signal (electrical voltage) produced during the deformation of the piezo cable of the sensor unit 11 is caused by a deformation or bending of the sensor unit 11. In order for this deformation of the piezo cable to occur under the action of an actuating force 21, the sensor unit 11 is surrounded by the sheath 16, e.g. made of foam, in the example shown, or underpadded by the support 17.

Such underpadding can have a thickness of 1 to 2 mm, for example, so that usable signals can be generated for the monitoring unit 7.

The sensor unit 11 already supplies a voltage as piezo cable with the sensor element 12 as piezo electrical component (e.g. layers or windings or the like made of a suitable material such as a thermoplastic material such as polyvinylidene fluoride—PVDF), which voltage can be easily processed by e.g. a microcontroller of the monitoring unit 7.

In this way, the detection device 10 offers installation in any desired spatial way, e.g. on furniture 1.

After the actuation by the actuating force 21 has ended, the deformation of the detection device 10 caused by the actuating force 21 returns to the unactuated state according to FIG. 2. A new deformation can then take place again.

In an alternative embodiment, the sensor unit 11 can also have the piezo cable without a support 17, with which it is underpadded, or sheath 16, in which it is embedded. In this case, the immediate deformation of the piezo material is detected during direct clamping, or also indirect deformation due to bending of the furniture part on which the sensor unit 11 is mounted.

The piezo cable can, for example, be embedded directly into a groove on the underside of a tabletop or with an underpadding support 17 underneath.

FIGS. 4 and 5 show a schematic representation of a variant of the detection device 10 according to the invention and according to FIG. 1 in an unactuated state and in an actuated state.

In this variant, the sensor unit 11 consists of flat material in contrast to the sensor unit 11 according to FIGS. 2 and 3. This can also be designed, for example, as a flexible printed circuit board.

The sensor element 12 is thus designed using PVDF as a flat strip, e.g. as foil, wherein the lines 13, 14 can be flat conductors, e.g. copper conductor tracks of a flexible printed circuit board or the like. This allows a very flat design of the detection device 10.

Alternatively, the sensor element 12 can be designed as a spatial element with elevations and depressions, which is elastically flexible around several axes and, optionally, along its length. When an actuating force 21 is applied, the sensor element 12 deforms itself and the lines 13, 14 attached to the sensor element 12 detect the electrical signal generated by the deformation. A further embodiment of such a sensor element 12 has openings, wherein the sensor element 12 itself is designed as a grid or net. Alternatively, the grid-shaped or net-shaped sensor element 12 can be designed as a planar and flat element.

The invention is not restricted by the embodiment examples described above, but can be modified within the framework of the appended claims.

For example, it is conceivable that in addition to the detection device 10 with the piezo cable as sensor unit 11 further sensors, e.g. with bending-sensitive resistors and the like, can be used.

When evaluating the signals of the detection device, a voltage supplied by the piezo cable can be analyzed, optionally after the mentioned amplification and/or filtering. For this purpose, at least one threshold value can be defined to which an action of the connected control device of the furniture drive mechanism is connected, e.g. deceleration, stopping and/or reversal of the direction of movement of a connected adjustment drive mechanism.

A voltage curve can also be analyzed in order to determine, for example, a time period for which a threshold value is exceeded. A gradient of the signal can also be determined, which is compared with threshold values for this quantity. The analysis of the time course, in particular the gradient, can provide information about the type of event detected.

This makes it possible, for example, to distinguish between clamping cases and vibrations, which can also generate a signal. In a preferred further development, it can be provided that certain vibrations such as knocking on a table top or tapping on the table top in a certain predetermined rhythm (pattern) are detected. For example, one or more knocking or tapping patterns can be distinguished from each other and used to control the adjustment drive mechanisms.

It may also be provided that the control device or the monitoring unit of the furniture drive mechanism has at least one separate signal or switching output which is activated after recognition of a predefined or teachable knocking or tapping pattern and triggers or switches connected devices such as a luminaire.

The monitoring unit can be designed as an electronic circuit operating in an analog manner. Alternatively, or in sections, the monitoring unit may also be a digitally operating circuit comprising a microcontroller having a program with one or more program sections.

In this case, at least one program section may be provided in one embodiment, which within the framework of the executable program of the microcontroller carries out the filter analysis mentioned at the beginning or the discrimination mentioned at the beginning, whether or not a detected signal corresponds to a clamping case. The decisive factor here (also as described above) is the character or course of the signal itself. If, for example, the time gradient of the signal lies within predetermined threshold value limits, then there is a clamping case.

Furthermore, several parameters can be logically linked by the respective program section. If the gradient of the signal is significantly higher and lies within other threshold limits and the signal drops again within a predetermined period of time, it will concern an interference pulse. However, if the signal repeats within a predetermined period of time with a predetermined number, the respective program section evaluates this as intentional action and by the user and carries out the action mentioned at the beginning, for example switching a lamp.

### LIST OF REFERENCE NUMERALS

1 Item of furniture
2 Top
3 Support leg
4 Electromotive furniture drive mechanism
4a, 4b Adjustment drive mechanism
5 Control device
5a, 5b Drive line
6 Operating unit
6a Transmission path
7 Monitoring unit
7a Connecting line
7b Connection cable
8 Clamping edge
9 Monitoring region
10 Detection device
11 Sensor unit
12 Sensor element
13, 14 Line
15 Insulation
16 Sheath
17 Support
18 Fixing side
19 Connection side
20 Actuating side
21 Actuating force

1.-14. (canceled)

15. An electromotive furniture drive for adjusting a movable component of an item of furniture, in particular functional furniture, said electromotive furniture drive comprising:
an electromotive adjustment drive mechanism including a control device and an operating device; and
a monitoring device including a detection device for monitoring a monitoring region and forming an anti-trap protection system for the item of furniture to be assigned, said detection device including a sensor unit which is designed as a piezo cable or comprises a piezo cable.

16. The electromotive furniture drive of claim 15, wherein the sensor unit includes a support as underpadding.

17. The electromotive furniture drive of claim 15, wherein the sensor unit includes a sheath.

18. The electromotive furniture drive of claim 15, wherein the sensor unit is configured for automatic reset after undergoing a deformation by an actuating force.

19. The electromotive furniture drive of claim 15, wherein the sensor unit includes two electrically conductive lines as connection cables.

20. The electromotive furniture drive of claim 15, wherein the piezo cable has a round cross-section.

21. The electromotive furniture drive of claim 15, wherein the sensor unit comprises a PVDF layer.

22. The electromotive furniture drive of claim 15, wherein the piezo cable is formed as a flat cable.

23. The electromotive furniture drive of claim 22, wherein the flat cable is a flexible printed circuit board.

24. The electromotive furniture drive of claim 15, wherein the monitoring device is configured to evaluate a signal from the detection device with regard to an amplitude and/or a signal characteristic.

25. The electromotive furniture drive of claim 24, wherein the monitoring device is configured to discriminate signals after various events on the basis of the amplitude and/or the signal characteristic.

26. The electromotive furniture drive of claim 25, wherein the monitoring device and the control device are configured to slow down, stop and/or reverse a direction of movement of the electromotive adjusting drive after detection of a certain event.

27. The electromotive furniture drive of claim 25, further comprising a separate signal or switching output which is activated when a predeterminable one of the events is recognized.

28. An item of furniture, comprising an electromotive furniture drive which comprises an electromotive adjustment drive mechanism including a control device and an operating device, and a monitoring device including a detection device for monitoring a monitoring region and forming an anti-trap protection system for the item of furniture to be assigned, said detection device including a sensor unit which is designed as a piezo cable or comprises a piezo cable.

29. The item of furniture of claim 28, wherein the piezo cable has a round cross-section.

30. The item of furniture of claim 28, wherein the piezo cable is formed as a flat cable.

31. The item of furniture of claim 30, wherein the flat cable is a flexible printed circuit board.

32. The item of furniture of claim 28, wherein the monitoring device is configured to evaluate a signal from the detection device with regard to an amplitude and/or a signal characteristic.

33. The item of furniture of claim 28, wherein the monitoring device and the control device are configured to slow down, stop and/or reverse a direction of movement of the electromotive adjusting drive after detection of a certain event.

34. The item of furniture of claim 33, wherein the electromotive furniture drive includes a separate signal or switching output which is activated when the event is recognized.
